(19) United States
(12) Patent Application Publication
(10) Pub. No.: US 2025/0224162 A1
(43) Pub. Date: Jul. 10, 2025

(54) INLINE REFRIGERANT MIXER FOR THERMOSTATIC EXPANSION VALVE BULB ASSOCIATED WITH REFRIGERATION CIRCUITS AND HEAT EXCHANGERS

(71) Applicant: Carrier Corporation, Palm Beach Gardens, FL (US)

(72) Inventors: James Amick, Danville, IN (US); Abdel Rahman Farraj, Indianapolis, IN (US); Logan Crum, Indianapolis, IN (US); Kaleb Rockwell, Camby, IN (US)

(21) Appl. No.: 18/989,281

(22) Filed: Dec. 20, 2024

Related U.S. Application Data
(60) Provisional application No. 63/617,667, filed on Jan. 4, 2024.

(51) Int. Cl. F25B 41/40; B01F 25/4314; B01F 35/213; F25B 41/31

(52) U.S. Cl. CPC F25B 41/40; B01F 25/43141; B01F 35/213; F25B 41/31; F25B 2341/0683

(57) ABSTRACT

Described herein is a refrigeration circuit. The refrigeration circuit comprises an evaporator coil comprising an inlet fluidically connected to an outlet of a condenser coil via a thermostatic expansion valve (TXV) and an outlet in thermal communication with a sensing bulb associated with the TXV, wherein the sensing bulb is configured to monitor temperature of a fluid exiting the outlet of the evaporator coil and correspondingly actuate the TXV to control pressure of the fluid supplied by the condenser coil into the evaporator coil; and a fluid mixer configured downstream of the outlet of the evaporator coil, wherein the fluid mixer is configured to uniformly mix the fluid exiting the evaporator coil, and wherein the sensing bulb is configured to sense temperature of the uniformly mixed fluid.

### CROSS-REFERENCE TO RELATED APPLICATION

This patent application claims the benefit of U.S. Provisional Patent Application No. 63/617,667, filed on Jan. 4, 2024, which is incorporated by reference herein in its entirety.

### BACKGROUND

The subject disclosure relates to the field of microchannel heat exchangers, and more particularly, an inline refrigerant mixer for a sensing bulb associated with a thermostatic expansion valve of with refrigeration circuits and heat exchangers.

### SUMMARY

Described herein is a refrigeration circuit. The refrigeration circuit comprises an evaporator coil comprising an inlet fluidically connected to an outlet of a condenser coil via a thermostatic expansion valve (TXV) and an outlet in thermal communication with a sensing bulb associated with the TXV, wherein the sensing bulb is configured to monitor temperature of a fluid exiting the outlet of the evaporator coil and correspondingly actuate the TXV to control pressure of the fluid supplied by the condenser coil into the evaporator coil; and a fluid mixer configured downstream of the outlet of the evaporator coil, wherein the fluid mixer is configured to uniformly mix the fluid exiting the evaporator coil, and wherein the sensing bulb is configured to sense the temperature of the uniformly mixed fluid.

In one or more embodiments, the evaporator coil is associated with a microchannel heat exchanger, wherein the evaporator coil comprises a plurality of microchannel tubes fluidically connected to and extending between an inlet header and an outlet header of the heat exchanger.

In one or more embodiments, the refrigeration circuit comprises a suction tube fluidically connected to the outlet of the evaporator coil and in thermal communication with the sensing bulb, wherein the fluid mixer is configured within the suction tube.

In one or more embodiments, an inlet of the condenser coil is fluidically connected to the outlet of the evaporator coil via a compressor.

Also described herein is a microchannel heat exchanger. The heat exchanger comprises a heat exchange coil comprising a plurality of microchannel tubes fluidically connected to and extending between an inlet header and an outlet header; a thermostatic expansion valve (TXV) fluidically connecting a condenser coil to the inlet header, wherein a sensing bulb associated with the TXV is in thermal communication with the outlet header and configured to monitor temperature of a fluid exiting the evaporator coil into the outlet header and correspondingly actuate the TXV to control pressure of the fluid supplied into the inlet header; and a fluid mixer configured downstream of the outlet of the evaporator coil or the outlet header, wherein the fluid mixer is configured to uniformly mix the portion of the fluid exiting the evaporator coil or the outlet header, and wherein the sensing bulb is configured to sense the temperature of the uniformly mixed fluid.

In one or more embodiments, the heat exchanger comprises a suction tube fluidically connected to the outlet of the evaporator coil or the outlet header and in thermal communication with the sensing bulb, wherein the fluid mixer is configured within the suction tube.

In one or more embodiments, the fluid mixer comprises one or more mixing elements disposed coaxially at predefined positions within the suction tube.

In one or more embodiments, the fluid mixer is coaxially disposed at the first end within the suction tube.

In one or more embodiments, the one or more mixing elements extend coaxially along a length of the suction tube.

In one or more embodiments, the one or more mixing elements is a static mixer.

In one or more embodiments, the one or more mixing elements is a longitudinal structure twisted helically in an axial direction.

In one or more embodiments, the one or more mixing elements is a helical structure having a threaded profile extending along a length of the structure.

In one or more embodiments, the one or more mixing elements is a helical static mixer that comprises a helical structure having one or more cuts, wherein a section of the helical structure between each of the cuts is alternatingly twisted by a predefined angle that causes the fluid flowing through the suction tube to be mixed.

The foregoing summary is illustrative only and is not intended to be in any way limiting. In addition to the illustrative aspects, embodiments, and features described above, further aspects, embodiments, features, and techniques of the disclosure will become more apparent from the following description taken in conjunction with the drawings.

### BRIEF DESCRIPTION OF THE DRAWINGS

The accompanying drawings are included to provide a further understanding of the disclosure and are incorporated in and constitute a part of this specification. The drawings illustrate exemplary embodiments of the disclosure and, together with the description, serve to explain the principles of the disclosure.

In the drawings, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary representation depicting a refrigeration circuit having an inline mixer downstream of the outlet of the evaporator coils in accordance with one or more embodiments of the disclosure.

FIGS. 2A and 2B illustrate exemplary representations depicting a microchannel heat exchanger for the evaporator of FIG. 1, having an inline mixer in the suction tube extending from the outlet header in accordance with one or more embodiments of the disclosure.

FIG. 3 illustrates an exemplary view of an embodiment of the inline mixer in accordance with one or more embodiments of the disclosure.

FIG. 4 illustrates an exemplary view of another embodiment of the inline mixer in accordance with one or more embodiments of the disclosure.

### DETAILED DESCRIPTION

The following is a detailed description of embodiments depicted in the accompanying drawings. The embodiments are in such detail as to clearly communicate the disclosure. However, the amount of detail offered is not intended to limit the anticipated variations of embodiments on the contrary, the intention is to cover all modifications, equivalents, and alternatives falling within the spirit and scope of the disclosure as defined by the appended claims.

Various terms are used herein. To the extent a term used in a claim is not defined below, it should be given the broadest definition persons in the pertinent art have given that term as reflected in printed publications and issued patents at the time of filing.

In the specification, reference may be made to the spatial relationships between various components and to the spatial orientation of various aspects of components as the devices are depicted in the attached drawings. However, as will be recognized by those skilled in the art after a complete reading of the disclosure, the components of the disclosure described herein may be positioned in any desired orientation. Thus, the use of terms such as “above,” “below,” “upper,” “lower,” “first”, “second” or other like terms to describe a spatial relationship between various components or to describe the spatial orientation of aspects of such components should be understood to describe a relative relationship between the components or a spatial orientation of aspects of such components, respectively, described herein may be oriented in any desired direction.

Refrigeration systems commonly employ evaporator coils equipped with a thermostatic expansion valve (TXV) at the inlet to regulate the flow of refrigerant into the evaporator. The TXV's sensing bulb, typically in thermal connection with the outlet of the evaporator coil, plays an important role in monitoring the superheat temperature of the refrigerant exiting the evaporator. This information is utilized to adjust the pressure of the refrigerant entering the evaporator coil, for improving the performance and energy efficiency of the refrigeration system.

Despite the widespread adoption of this configuration, challenges arise when microchannel tubes are employed in the construction of evaporator coils. Microchannel tubes offer advantages such as increased heat transfer efficiency and reduced refrigerant charge. However, they also introduce the potential for mal-distribution of refrigerant flow within the evaporator coils. This mal-distribution can lead to uneven cooling across the coil and, more critically, interfere with the accurate sensing of refrigerant temperature by the TXV's sensing bulb. The mal-distribution issue becomes particularly pronounced when attempting to maintain precise control over the refrigerant pressure entering the evaporator coils. Furthermore, inaccurate sensing of refrigerant temperature at the outlet of the evaporator coil can lead to further complications in maintaining optimal superheat conditions.

There is therefore a need to provide a simple and robust solution to ensure that the area of refrigerant sensing control (TXV bulb) is better mixed to make sure the TXV bulb operates properly, thereby enabling accurate and repeatable sensing of the single-phase vapor temperature exiting the evaporator coil.

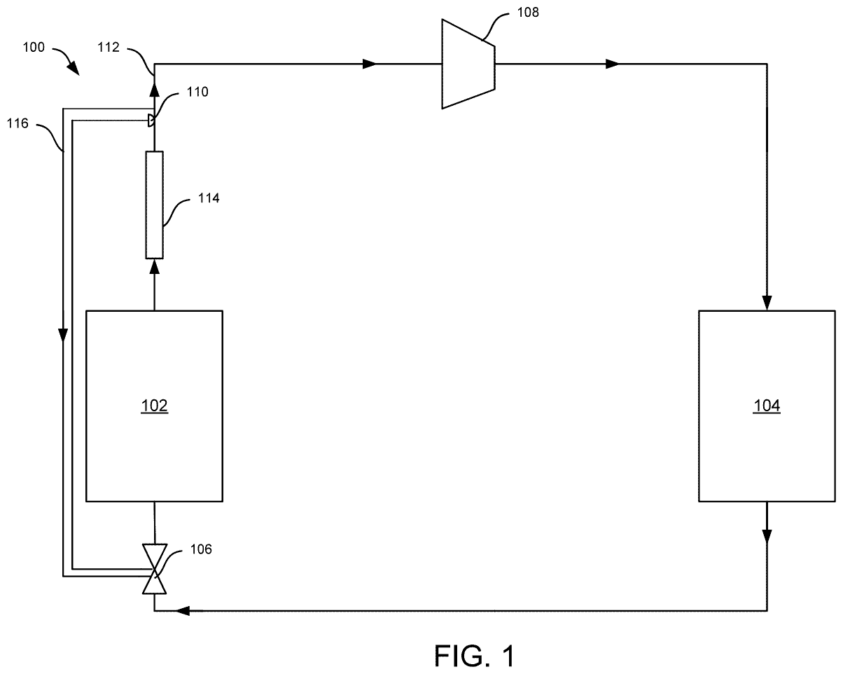

Referring to FIG. 1, a refrigeration circuit 100 is disclosed. The refrigeration circuit 100 can include an evaporator 102 that comprises an evaporator coil (also designated as 102, herein) having an inlet fluidically connected to an outlet of a condenser coil 104 associated with a condenser (also designated as 104, herein) via a thermostatic expansion valve (TXV) 106. Further, an inlet of the condenser coil 104 can be fluidically connected to an outlet of the evaporator coil 102 via a compressor 108. In addition, the outlet of the evaporator coil can be in thermal communication with a sensing bulb 110 (also referred to as TXV bulb 110, herein) associated with the TXV. The refrigerant circuit 100 can include a suction tube 112 (made of copper and the like) extending from the outlet of the evaporator coil 102. The suction tube 112 can be further fluidically connected to the TXV 106 via a pressure equalizer tube 116. The sensing bulb 110 can be in thermal contact with the suction tube 112 to monitor temperature of a fluid (two-phase refrigerant) exiting from the outlet of the evaporator coil 102 and correspondingly actuate the TXV 106 to control the pressure of the fluid supplied by the condenser coil 104 into the evaporator coil 102.

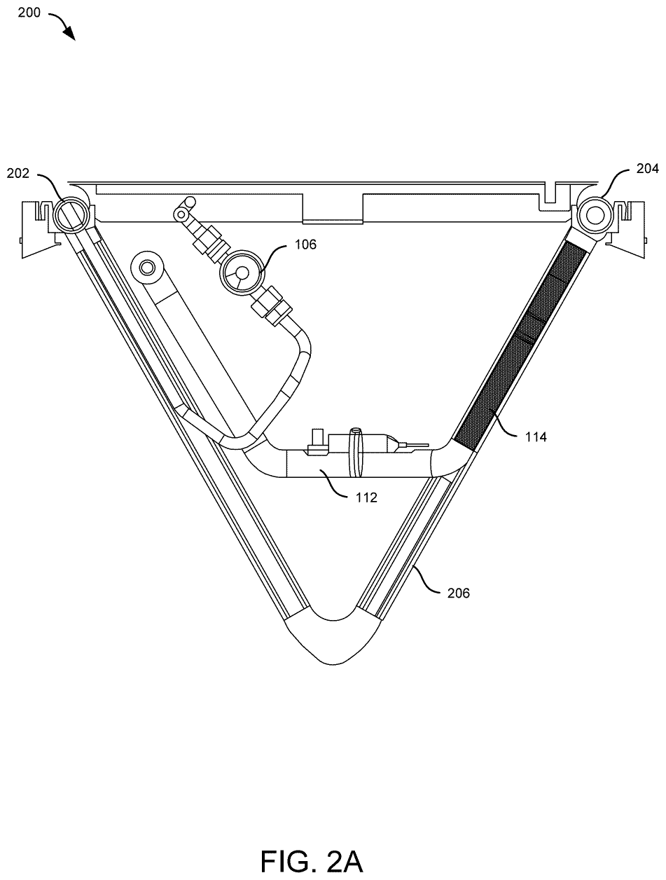

In one or more embodiments, the evaporator coil 102 can be associated with a microchannel heat exchanger (200 of FIGS. 2A and 2B) that can be configured as the evaporator. The heat exchanger can have a plurality of microchannel tubes extending between the inlet and outlet of the evaporator coil 102. Similarly, the condenser coil 104 can also be associated with another microchannel heat exchanger (that can be configured as the evaporator) having a plurality of microchannel tubes extending between the inlet and outlet of the condenser coil 104.

Referring to FIGS. 2A and 2B, a microchannel heat exchanger 200 for the evaporator 102 of FIG. 1 is disclosed. The heat exchanger 200 can include a heat exchange coil (evaporator coil 102) 102 comprising a plurality of microchannel tubes 206 fluidically connected to and extending between an inlet header 202 and an outlet header 204. Further, the heat exchanger 200 can include the TXV 106 fluidically connecting an outlet of a condenser coil 104 associated with the refrigeration circuit 100 to the inlet header 202 of the heat exchanger 200 (evaporator). In addition, the sensing bulb 110 associated with the TXV 106 can be in thermal communication with the outlet header 204, which can be configured to monitor the temperature of a fluid (refrigerant) exiting from the evaporator coil 102 into the outlet header 204 and correspondingly actuate the TXV 106 to control the pressure of the fluid supplied into the inlet header 202. In one or more embodiments, a suction tube 112 can extend between the outlet header 204 and the compressor 108, where the sensing bulb 110 can be in thermal contact with a body of the suction tube 112 to allow the sensing bulb 110 to monitor the temperature of the fluid exiting from the outlet of the evaporator coil 102 or the outlet header 204. Further, the suction tube 112 can also be fluidically connected to the TXV 106 via a pressure equalizer pipe 116.

While FIGS. 2A and 2B and some embodiments have been elaborated for the V-coil arrangement heat exchanger for the sake of simplicity and better explanation purpose, the teachings of the subject disclosure are equally applicable for other heat exchanger(s) having upward or downward fluid flow configuration such as A-coil heat exchanger, slab-design heat exchanger, N-coil heat exchanger, J-coil heat exchanger, U-coil heat exchanger, and the like, and all such embodiments are well within the scope of the subject disclosure.

Referring to FIGS. 1 to 2B, the TXV 106 can be configured to control the amount (volume) of refrigerant released into or supplied to the evaporator coil 102 or inlet header 202 and further regulate the superheat of the refrigerant that flows out of the evaporator coil 102 to a predetermined steady value. The TXV 106 can have the sensing bulb 110 that can be filled with a liquid whose thermodynamic properties are similar to those of the refrigerant. In one or more embodiments, the TXV sensing bulb 110 can be thermally connected to the output of the evaporator coil 102 or the outlet header 204 of the heat exchanger 200, so that the temperature of the refrigerant that leaves the evaporator coil 102 can be sensed.

The gas pressure in the sensing bulb 110 can provide the force to open the TXV 106, and as the temperature drops this force may decrease, therefore dynamically adjusting the flow of refrigerant into the evaporator coil 102 or the inlet header 202. Superheat is the excess temperature of the vapor above its boiling point at the evaporating pressure. For instance, no superheat indicates that the refrigerant is not being fully vaporized within the evaporator coil 102 and liquid may end up recirculated to the compressor 108 which can be inefficient and can cause damage. On the other hand, excessive superheat indicates that there is insufficient refrigerant flowing through the evaporator coil 102, and thus a significant portion of the refrigerant toward the outlet end of the evaporator coil 102 is not providing cooling.

In one or more embodiments, the refrigeration circuit 100 and the heat exchanger 200 can include an inline mixer 114 (also referred to as fluid mixer or mixer 114, herein) being configured within the suction tube 112 connecting the outlet of the evaporator coil 102 or the outlet header 204 to the compressor 108. The mixer 114 can be configured to receive and uniformly mix the fluid (refrigerant) exiting the evaporator coil 102 or from the outlet header 204. The TXV sensing bulb 110 being in thermal contact with the suction tube 112 can then sense the temperature of the uniformly mixed refrigerant exiting from the mixer 114.

Mixing the portion of the refrigerant (exiting the evaporator coil 102) before being sensed by the sensing bulb 110 can mitigate the chances of any inaccurate sensing of the refrigerant temperature by the TXV's sensing bulb 110, thereby facilitating in maintaining optimal superheat conditions. Accordingly, the TXV 106 can maintain precise control over the refrigerant pressure entering the evaporator coil 102 or inlet header 202, thereby preventing the chances of mal-distribution of refrigerant flow within the evaporator coil 102 and enabling even cooling across the evaporator coil 102.

In one or more embodiments, the fluid mixer 114 can include one or more mixing elements (also designated as 114, herein) disposed coaxially at predefined positions within the suction tube 112 connecting the outlet of the evaporator coil 102 or the outlet header 204 with the sensing bulb 110 of the TXV 106. In one or more embodiments, the fluid mixer or the mixing elements 114 can be coaxially disposed at the first end (the evaporator coil 102 outlet end) within the suction tube 112. However, in other embodiments, the fluid mixer or the mixing elements 114 can be also coaxially disposed at the second end and/or middle section within the suction tube 112, without any limitation. Further, in one or more embodiments, the one or more mixing elements 114 can extend coaxially along an entire length of the suction tube 112.

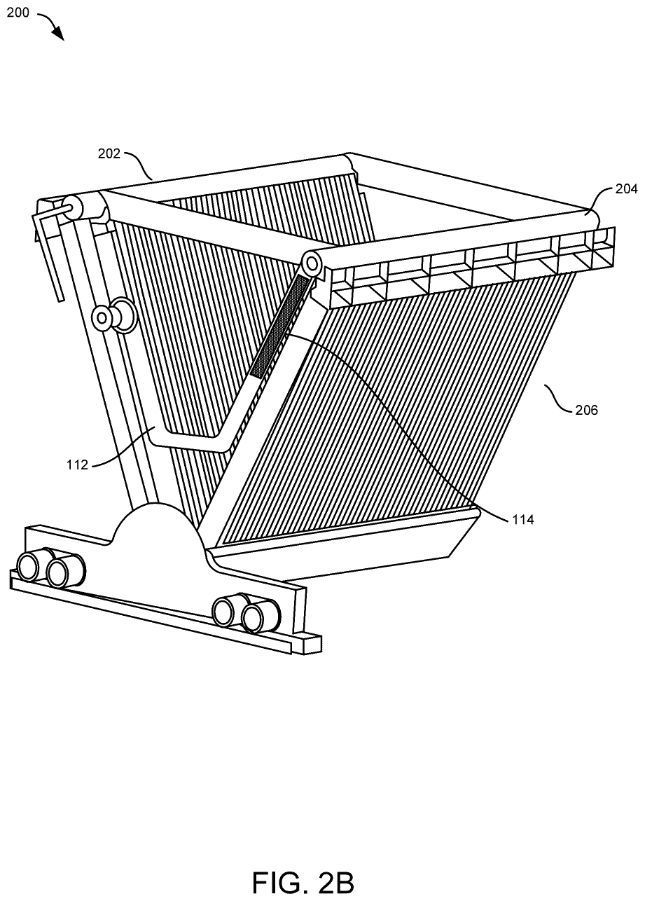

In one or more embodiments, the one or more mixing elements 114 can be a static mixer which can be coaxially disposed within the suction tube 112. Referring to FIG. 3, in one or more embodiments, the one or more mixing elements 114 can be a helical structure having a threaded profile T extending along the length of the structure. Further, not shown, in one or more embodiments, the one or more mixing elements 114 can be a longitudinal structure twisted helically in an axial direction.

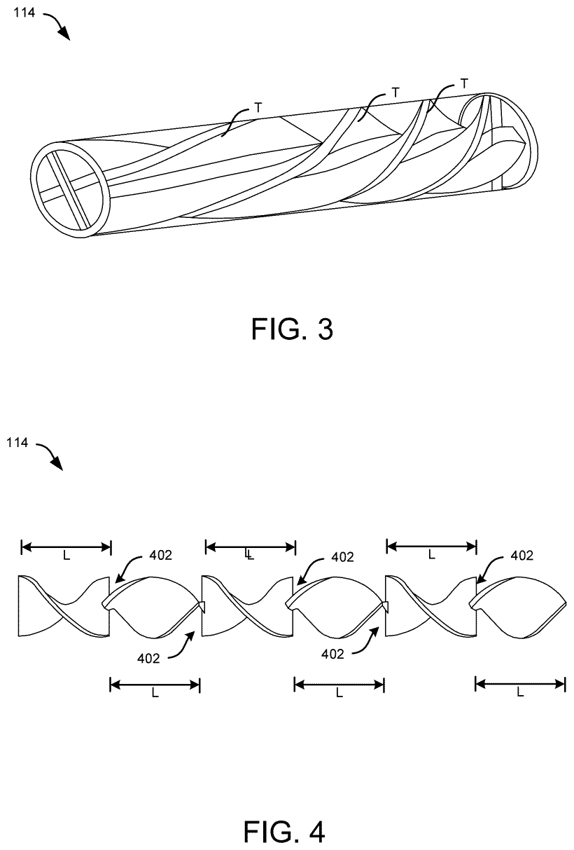

Referring to FIG. 4, in one or more embodiments, the one or more mixing elements 114 can be a helical static mixer that can include a helical structure having one or more cuts 402 at predefined lengths L, where a section of the helical structure between each of the cuts 402 can be alternatingly twisted in left and right-hand directions by a predefined angle. Accordingly, the structure of the helical static mixer 114 can cause the refrigerant (fluid) flowing through the suction tube 112 to move from a wall of the suction tube 112 towards the center of the mixing element 114 and from the center towards the wall in an alternating manner, thereby cutting the refrigerant flow into half and rotating by 180 degrees at each of the cuts and effectively mixing the refrigerant before supplying to the TXV bulb 110.

While various embodiments of the subject disclosure have been elaborated for the fluid mixer 114 (in the suction tube 112) being a static mixer having a helical profile or a helical static mixer, the teachings of the subject disclosure are equally applicable for any other type of fluid mixer having a different shape or types as long as such fluid mixer mixes the two-phase refrigerant in the suction tube 112 before supplying to the sensing bulb 110 of the TXV 106, and all such embodiments are well within the scope of the subject disclosure.

Thus, the subject disclosure overcomes the drawbacks, limitations, and shortcomings associated with existing heat exchangers and TXV by providing a simple and effective solution in the form of the inline mixer 114 configured in the suction tube 112 connecting the outlet of the evaporator coil 102 and the compressor 108. The mixing of the portion of the refrigerant (exiting the evaporator coil 102) by the inline mixer 114 before being sensed by the sensing bulb 110 mitigates the chances of any inaccurate temperature sensing of the refrigerant temperature by the TXV's sensing bulb 110 and further facilitates maintaining optimal superheat conditions. This can enable TXV 106 to maintain precise control over the refrigerant pressure entering the evaporator coil 102 or inlet header 202, thereby preventing the chances of mal-distribution of refrigerant flow within the evaporator coil 102 and enabling even cooling across the evaporator coil 102.

While the disclosure has been described with reference to exemplary embodiments, it will be understood by those skilled in the art that various changes may be made and equivalents may be substituted for elements thereof without departing from the scope of the disclosure as defined by the appended claims. Modifications may be made to adopt a particular situation or material to the teachings of the disclosure without departing from the scope thereof. Therefore, it is intended that the disclosure not be limited to the particular embodiment disclosed, but that the disclosure includes all embodiments falling within the scope of the disclosure as defined by the appended claims.

In interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

1. A refrigeration circuit comprising:
an evaporator coil comprising an inlet fluidically connected to an outlet of a condenser coil via a thermostatic expansion valve (TXV) and an outlet in thermal communication with a sensing bulb associated with the TXV,
wherein the sensing bulb is configured to monitor temperature of a fluid exiting the outlet of the evaporator coil and correspondingly actuate the TXV to control pressure of the fluid supplied by the condenser coil into the evaporator coil; and
a fluid mixer configured downstream of the outlet of the evaporator coil, wherein the fluid mixer is configured to uniformly mix the fluid exiting the outlet of the evaporator coil,
wherein the sensing bulb is configured to sense the temperature of the uniformly mixed fluid.

2. The refrigeration circuit of claim 1, wherein the evaporator coil is associated with a microchannel heat exchanger, and wherein the evaporator coil comprises a plurality of microchannel tubes fluidically connected to and extending between an inlet header and an outlet header of the microchannel heat exchanger.

3. The refrigeration circuit of claim 1, wherein the refrigeration circuit further comprises a suction tube fluidically connected to the outlet of the evaporator coil and in thermal contact with the sensing bulb, and wherein the fluid mixer is configured within the suction tube.

4. The refrigeration circuit of claim 1, wherein the fluid mixer comprises one or more mixing elements disposed coaxially at predefined positions within the suction tube.

5. The refrigeration circuit of claim 1, wherein the fluid mixer is coaxially disposed at a first end within the suction tube.

6. The refrigeration circuit of claim 1, wherein the one or more mixing elements extend coaxially along a length of the suction tube.

7. The refrigeration circuit of claim 1, wherein the one or more mixing elements is a static mixer.

8. The refrigerant circuit of claim 1, wherein the one or more mixing elements is a longitudinal structure twisted helically in an axial direction.

9. The refrigerant circuit of claim 1, wherein the one or more mixing elements is a helical structure having a threaded profile extending along a length of the structure.

10. The refrigeration circuit of claim 1, wherein the one or more mixing elements is a helical static mixer that comprises a helical structure having one or more cuts, and wherein a section of the helical structure between each of the cuts is alternatingly twisted by a predefined angle that causes the fluid flowing through the suction tube to be mixed.

11. The refrigeration circuit of claim 1, wherein an inlet of the condenser coil is fluidically connected to the outlet of the evaporator coil via a compressor.

12. A microchannel heat exchanger comprising:
a heat exchange coil comprising a plurality of microchannel tubes fluidically connected to and extending between an inlet header and an outlet header;
a thermostatic expansion valve (TXV) fluidically connecting a condenser coil to the inlet header, wherein a sensing bulb associated with the TXV is in thermal contact with the outlet header and configured to monitor temperature of a fluid exiting an evaporator coil into the outlet header and correspondingly actuate the TXV to control pressure of the fluid supplied into the inlet header; and
a fluid mixer configured downstream of an outlet of the evaporator coil or the outlet header, wherein the fluid mixer is configured to uniformly mix the fluid exiting the evaporator coil or the outlet header,
wherein the sensing bulb is configured to sense the temperature of the uniformly mixed fluid.

13. The microchannel heat exchanger of claim 12, wherein the heat exchanger comprises a suction tube fluidically connected to the outlet of the evaporator coil or the outlet header and in thermal communication with the sensing bulb, and wherein the fluid mixer is configured within the suction tube.

14. The microchannel heat exchanger of claim 12, wherein the fluid mixer comprises one or more mixing elements disposed coaxially at predefined positions within the suction tube.

15. The microchannel heat exchanger of claim 12, wherein the fluid mixer is coaxially disposed at a first end within the suction tube.

16. The microchannel heat exchanger of claim 12, wherein the one or more mixing elements extend coaxially along a length of the suction tube.

17. The microchannel heat exchanger of claim 12, wherein the one or more mixing elements is a static mixer.

18. The microchannel heat exchanger of claim 12, wherein the one or more mixing elements is a longitudinal structure twisted helically in an axial direction.

19. The microchannel heat exchanger of claim 12, wherein the one or more mixing elements is a helical structure having a threaded profile extending along a length of the structure.

20. The microchannel heat exchanger of claim 12, wherein the one or more mixing elements is a helical static mixer that comprises a helical structure having one or more cuts, and wherein a section of the helical structure between each of the one or more cuts is alternatingly twisted by a predefined angle that causes the fluid flowing through the suction tube to be mixed.
